(19) United States
(12) Patent Application Publication
(10) Pub. No.: US 2020/0330805 A1
(43) Pub. Date: Oct. 22, 2020

(54) Fire-Extinguishing Bag

(71) Applicant: SACS GmbH, Empfingen (DE)

(72) Inventors: Jan SCHOLTENS, Hattern (NL); Claude VALERIUS, Niederneisen (DE); Joseph SCHNOELL, Muenchen (DE)

(73) Assignee: SACS GmbH, Empfingen (DE)

(21) Appl. No.: 16/087,987

(22) PCT Filed: Mar. 30, 2017
(86) PCT No.: PCT/EP2017/000389

§ 371 Date: Sep. 24, 2018

(30) Foreign Application Priority Data
Apr. 1, 2016 (EP) 16000766.2

(51) Int. Cl. A62C 8/06; A62C 2/04; A62C 3/00

(52) U.S. Cl. CPC A62C 8/06; A62C 3/00; A62C 2/04

(57) ABSTRACT

A flexible bag includes an inner compartment for receiving a hot and/or burning object, the bag being able to be rolled up and/or folded, and including an opening for the insertion of the object into the inner compartment. The bag further includes an outer compartment that can be accessed from the exterior on the third of the bag lying opposite the opening. A fire extinguisher is housed in the outer compartment in order to hold and dispense a fire-extinguishing agent.

### CROSS REFERENCE TO RELATED APPLICATIONS

This application claims the priority of International Application No. PCDEP2017/000389, filed Mar. 30, 2017, and European Patent Document No, 16000766.2 filed Apr. 1, 2016, the disclosures of which are expressly incorporated by reference herein.

### BACKGROUND AND SUMMARY OF THE INVENTION

The invention relates to a flexible bag comprising an inner compartment for receiving a hot and/or burning object, where the bag can be rolled up and/or folded and where the bag has an opening for the insertion of the object into the inner compartment of the bag.

One of the greatest dangers in air travel is tires in the flying aircraft. More and more often, these tires are triggered by lithium-ion batteries, which are found in the electronic devices, such as, for example, notebooks or smartphones, of the passengers. In larger aircraft, in some instances up to 500 batteries fly in the pockets of the passengers.

The batteries store large quantities of energy. If, because of technical defects or improper handling, an uncontrolled and accelerated discharge of the chemically stored energy occurs, this generally takes place as thermal energy. This inevitably leads to a short circuit and consequently to a fire.

Particular dangers originate from burning lithium-ion batteries. In the event of improper extinguishing attempts, it is possible for a sudden liberation of energy, acceleration of tire or an explosion to occur.

Lithium cells are generally closed in a gas-tight manner, so that in regular normal operation no contents can escape. However, if the housing is damaged mechanically or thermal loading arises as a result of a fire event, different corrosive, poisonous and carcinogenic substances, but also combustible contents (dusty, gaseous or in liquid form) can escape.

A further danger of lithium metal results in particular in the event of contact with water, e.g., extinguishing water. Here, the formation of hydrogen gas can occur, which as a gas mixture with air is capable of ignition over a very wide mixture ratio and in addition needs only very little ignition energy.

In addition, transition metals and fluorine-containing and/or phosphorus-containing compounds are frequently used in secondary batteries, which in the event of a fire can lead to reaction products that are harmful to health or poisonous and which, in the smoke from a fire, represent a considerable risk to persons and the environment. In the case of fires of lithium-ion batteries, even in common sizes, e.g., laptops, it is possible for critical endangerment as a result of hydrogen fluoride to occur.

It is therefore an object of the present invention to develop a device and method for extinguishing burning or hot objects. In particular, the intention is to be able to extinguish fires of electronic devices quickly and efficiently.

This object is achieved by a flexible bag comprising an inner compartment for receiving a bag and/or burning object, where the bag can be rolled up and/or folded and where the bag has an opening for the insertion of the object into the inner compartment of the bag, where the extent of the bag from its upper end to its opposite lower end defines its longitudinal direction, and where the bag is characterized in that the opening is located in the upper third of the bag and in that an outer compartment that is accessible from outside, in which a fire extinguisher to hold and discharge a fire-extinguishing agent is housed, is provided in the lower third of the bag, where the outer compartment is designed in such a way that, following the insertion into the outer compartment, the fire extinguisher is arranged essentially perpendicular to the longitudinal direction of the bag.

The bag is formed flexibly and can be rolled together or folded to small package dimensions. In its upper region, the bag has an opening, through which the object can be put into the interior of the bag, that is to say the inner compartment of the bag. The outer compartment for holding the fire extinguisher is located in the end region of the bag opposite to the opening. In the following text, if not otherwise specified, in order to simplify the description the upper half of the bag is that half in which the opening is located. Accordingly, the terms “lower end”, “lower third” and so on designate the corresponding portions located in the other half of the bag. In the following text, the length of the bag designates its extent from top to bottom, i.e., in the longitudinal direction. The width and thickness (also called the depth in the following text) of the bag designate the extent of the latter in the two directions perpendicular to the longitudinal direction.

The outer compartment for the fire extinguisher is located in the lower third of the bag. The outer compartment is designed such that, following the insertion into the outer compartment, the fire extinguisher or fire extinguishers is or are arranged in the direction of the width of the bag.

In order to store it, the bag is advantageously rolled up from the lower end around the fire extinguisher(s) located in the outer compartment. After being rolled up, the upper end of the bag is on the outside, the lower end of the bag inside in the center of the roll thus formed. This firstly has the advantage that the bag can be kept in a small and space-saving manner. This is advantageous in particular in vehicles, such as for example in a motor vehicle, or on board an aircraft. Secondly, when in use, the bag can be unrolled quickly. The bag merely has to be held firmly at its upper end, that is to say at the outer end of the roll. As a result of gravity, the bag is automatically unrolled because of the fire extinguisher located in the lower region of the bag, so that the bag can be used quickly.

The fire extinguisher is housed in an outer compartment accessible from outside. The bag can be grasped with a hand at the upper end and unrolled and the fire extinguisher can be activated with the other hand. A burning object can be extinguished very quickly in this way. For this purpose, the fire extinguisher can be removed from the outer compartment and the fire-extinguishing agent located in the fire extinguisher can be discharged. Depending on where the activation devices required for the discharge of the fire-extinguishing agent are located on the fire extinguisher, the fire extinguisher can if appropriate also remain in the outer compartment during the discharge of the fire-extinguishing agent.

The outer compartment for the fire extinguisher is provided in the lower region of the bag. Preferably, the outer compartment is designed such that the longitudinal axis of the fire extinguisher is oriented in the outer compartment so as to be essentially parallel to the lower end of the bag. This has the advantage that, when the bag is unrolled, the fire extinguisher is rotated about its longitudinal axis but remains in the outer compartment.

In a preferred embodiment, the bag comprises an upper part and a lower part, which are detachably connected to each other. The inner compartment of the bag, into which the hot object can be or is to be inserted, extends only over the upper part of the bag. The outer compartment is provided on the lower part of the bag. The upper and the lower part of the bag are detachably connected to each other, so that the lower part of the bag can be separated from the upper part. This has the advantage that, following the insertion of the hot object into the bag and the removal from the lower part, and on account of the then smaller volume, the upper part can be stowed better. The detachable connection between the upper and the lower part is preferably produced by means of a hook-and-loop fastener.

At least the upper part of the bag having the internal compartment, which is used to hold the hot object, advantageously consists of a fire-retardant or fire-resistant material. The fire-retardant or fire-resistant material withstands, for example, temperatures up to 500° C., 800° C. or 1000° C. over a time period of 60 min, 90 min or 120 min. For this purpose, for example, use is made of a glass fiber fabric, in particular an E-glass fabric. The glass fiber fabric can additionally be reinforced further with metallic fibers.

By means of a specific coating of the fabric, heat resistance with respect to these high temperatures can be achieved. In addition, the coating is advantageously extremely abrasion-resistant, which gives the bag a correspondingly long service life.

The seams are preferably made from a specific aramid fiber with metal reinforcement (Kevlar/Twaron and stainless steel).

The lower part that can be separated from the remainder of the bag can likewise consist of a fire-retardant or fire-resistant material. However, this is not absolutely necessary, since the lower part is separated following the insertion of the hot object into the inner compartment and therefore does not come into contact with the object. Of course, it is likewise possible to make the lower, separable part from fire-resistant material.

Provided on the outside of the bag is the outer compartment, in which a fire extinguisher is housed. If an object has caught tire, the fire is firstly extinguished with the aid of the fire extinguisher, and then the extinguished object is inserted into the inner compartment of the bag and stowed in a fireproof manner. Further propagation of the fire can thus be safely and effectively prevented.

It has proven to be advantageous to provide a handle or a handle opening in the upper region, preferably in the upper third or in the fifth or at the upper end of the bag, in order to be able to grip and hold the bag quickly, easily and safely. For example, a handle such as that in a shopping bag can be provided at the upper end of the bag. However, it is also possible for one or two side surfaces of the bag to be provided with a handle opening in the upper region.

As described, a burning object can be extinguished with the aid of the fire extinguisher located in the outer compartment of the bag. The object can then be inserted into the bag. The bag advantageously has a hook-and-loop fastener, so that the opening of the inner compartment can be closed following the insertion of the object. Therefore, further propagation of the fire is prevented. In addition, the escape of poisonous gases from the inner compartment is prevented. The inner compartment of the bag is preferably closed by means of a hook-and-loop fastener. Particularly preferably, a roll hook-and-loop fastener is used. This means that the bag is initially rolled up a little from top to bottom and the rolled-up piece is then fixed to the bag by means of a hook-and-loop fastener. The roll hook-and-loop fastener has the advantage of being particularly leak-proof against gas escape and, in addition, represents an effective heat closure.

The bag according to the invention is suitable in particular for combating burning or smoldering electronic devices, in particular communication and/or data processing devices, such as for example mobile telephones, smartphones or portable computers such as notebooks or tablets. Lit electric or electronic cigarettes can also be extinguished by the bag according to the invention.

The size of the inner compartment of the bag is advantageously matched to the size of the objects potentially to be extinguished. To hold the aforementioned electronic devices, a bag having a holding capacity between 1 l and 40 l, preferably between 2 l and 20 l, is particularly suitable. The bag is advantageously designed to be essentially rectangular or square. The inner compartment has dimensions of, for example, 60 cm×40 cm×6 cm or 50 cm×35 cm×5 cm. The inner compartment is preferably sufficiently large that a portable computer having a screen diagonal of 17 inches, i.e. having dimensions of approximately 30 cm×42 cm×4 cm, can be inserted into the inner compartment without difficulty. In the case of an essentially square inner compartment, the extent of the inner compartment in a first direction is preferably between 40 cm and 60 cm, in a second direction perpendicular thereto preferably between 25 cm and 40 cm and in the third direction, once more perpendicular thereto, preferably between 1 cm and 10 cm.

In a further embodiment of the invention, the bag has one or two compartments for one or two fire extinguishers. By using one of the fire extinguishers, a burning device, for example a laptop or a cell phone, can initially be roughly extinguished. The extinguished device is then put into the bag. In some instances, the devices have to be extinguished once more. In this case, by using the second fire extinguisher, spray is once more directed into the bag interior, in order to extinguish the fire completely and then to stow the device in a fireproof manner in the bag. As a result of the presence of two fire extinguishers, the security against failure of the bag is additionally increased. Even if one of the fire extinguishers should not function, the fire can be extinguished with the other fire extinguisher. Thus, the fastest possible firefighting is possible. This is of significant importance, for example in a fire in an aircraft.

For this purpose, in one embodiment the bag has a further compartment for holding a second fire extinguisher beside the already described compartment for the fire extinguisher in the lower bag region. Depending on the size of the bag and the size of the fire extinguisher, the compartments, i.e., the outer compartment for the first fire extinguisher and the compartment for the second fire extinguisher, can be arranged above one another, so that the compartments are located beside each other from top to bottom. However, the compartments can also be provided beside each other. “Above one other” is intended to designate the direction from bottom to top and “beside each other” the direction perpendicular thereto. Of course, the compartments can also be arranged to be offset relative to each other, that is to say to some extent above and to some extent beside each other.

It is also possible to provide a larger outer compartment, which is suitable to hold two or more fire extinguishers.

As explained above, the extinguished or previously extinguished device is to be put into the bag for fireproof sate keeping. For this purpose, fire-resistant gloves and/or protective glasses are advantageously provided in the bag. The fire-resistant gloves and/or the protective glasses are preferably wound into the bag, so that these can be gripped immediately as the bag is unrolled. However, it is also possible to provide a further compartment for the gloves and/or the protective glasses on the outside of the bag.

In a further embodiment of the bag, one or more tabs are provided, which are used to close the outer compartment or the outer compartments. The tab holds the fire extinguisher or fire extinguishers safely in the outer compartment, so that they cannot fall out. In addition, the gloves can be clamped under the tab(s) or held firmly by means of the tab(s).

The fire extinguisher or at least one of the fire extinguishers preferably contains no propellant gas or compressed air as propellant but is provided with an elastomer force element or an elastic filling bladder, in particular a filling bladder made of silicon rubber. This fire extinguisher type has the advantage that only a low pressure of less than 5 bar, less than 3 bar or at most 2 bar is present in the fire extinguisher, which means that there is no risk of explosion. Even in the event of damage to the outer sleeve of the fire extinguisher, the latter does not explode. In addition, because of the lack of a propellant gas, in such a fire extinguisher no aerosols or other substances that are combustible or harmful to health escape. Finally, because of the low pressure, the fire extinguisher does not have to be designed to be as pressure-resistant and solid as fire extinguishers filled with propellants. For example, the fire extinguisher can be made of aluminum or plastic instead of steel, which means that the weight is reduced considerably.

In a further embodiment, the bag is provided with a data carrier, on which data about the bag and/or the fire extinguisher can be stored and read. Preferably, a data carrier which permits storage and/or reading of the data without contact and without visual contact is provided. For example, an RFID data carrier (RFID=Radio Frequency Identification) or RFID transponder or RFID chip can be used for this purpose. Advantageously, the date of manufacture and the serial number of the fire extinguisher and/or of the bag and their respective manufacturer and/or the expiry date of the fire extinguisher are stored on the data carrier. Fire extinguishers have to be replaced, for example, at regular intervals, for example every three years. This is made substantially easier by the provision of such a data carrier.

The invention is preferably used for extinguishing portable electronic devices which have caught fire. The power supply of these devices is generally provided via batteries and in particular by means of lithium-ion batteries. A burning lithium-ion battery should not be extinguished with water. The fire extinguisher or fire extinguishers are therefore advantageously filled with a specific fire-extinguishing agent for lithium-ion batteries, in particular a fire-extinguishing agent for lithium-manganese batteries, lithium-polymer batteries, lithium-titanate batteries, lithium-iron phosphate batteries and other designs containing lithium ions.

The bag is preferably used in motor vehicles and on board aircraft and used to extinguish hot and/or burning objects, in particular electronic communication and/or data processing devices, such as portable telephones and portable computers.

In a preferred design, all the materials used for the bag are certified for air travel and correspond in particular to the stipulations of the EASA (European Aviation Safety Agency) and or the regulations of the US Federal air travel authority FAR (Federal Aviation Regulations)

The bag is preferably used to hold objects, in particular electric or electronic devices, which contain a battery based on lithium compounds, in particular a lithium-manganese battery, a lithium-polymer battery, a lithium-titanate battery, a lithium-iron phosphate battery or another design containing lithium ions.

The invention and further details of the invention will be explained in more detail below by using the schematic drawings.

### BRIEF DESCRIPTION OF THE DRAWINGS

FIG. 1 shows an embodiment of the bag according to the invention,

FIG. 2 shows a side view of the bag according to FIG. 1,

FIG. 3 shows the bag in the rolled-up state,

FIG. 4 shows an alternative embodiment of the invention, and

FIG. 5 shows a further embodiment of the invention of FIG. 1.

### DETAILED DESCRIPTION OF THE DRAWINGS

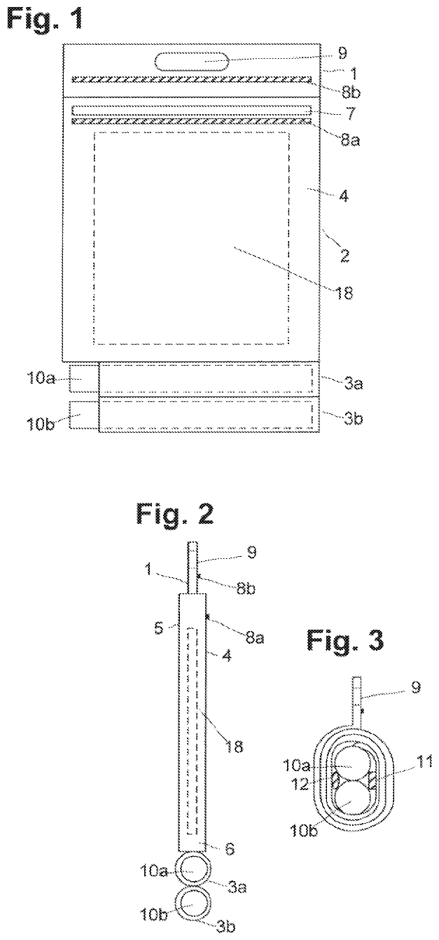

FIGS. 1 and 2 show a bag according to the invention which is suitable in particular for use on board aircraft.

The bag consists of a fire-retardant or fire-resistant flexible material, so that the bag can be easily rolled up and/or folded. The bag comprises an upper region 1, a middle region 2 and a lower region 3a, 3b.

The middle region 2 has a front part 4, a rear part 5 and side parts 6. The front part 4, the rear part 5 and the side parts 6 are connected to one another such that they form an inner compartment. It is also possible to dispense with the side parts 6 and to connect the front part 4 and the rear part 5 directly to each other. In a further variant, instead of separate front, rear and side parts, a tube-like structure is used.

Provided in the upper region of the front part 4 is a slot-like opening 7, which extends over more than 80%, preferably more than 90%, of the width of the front part 4. The opening 7 permits the insertion of an object 18 into the inner compartment of the bag.

Fitted underneath the opening 7 is a hook-and-loop tape 8a, which extends parallel to the opening 7 and over the entire length thereof. A corresponding hook-and-loop tape 8b which, together with the hook-and-loop tape 8a forms a detachable hook-and-loop fastener, is located above the opening 7. If the two hook-and-loop tapes 8a, 8b are brought on to one another, then they are connected reversibly and close the opening 7.

In addition, a handle opening 9 is incorporated in the upper region 1. Instead of the handle opening 9, a handle or a tab can also be provided, which is fixed to the upper region 1 or directly to the middle region 2. In the latter case, the upper region can also be omitted.

Provided in the lower region 3a, 3b of the bag are two compartments 3a, 3b, which are each used to hold an essentially cylindrical fire extinguisher 10a, 10b. The compartments 3a, 3b are arranged one under the other and each extend in the transverse direction, which means perpendicular to the connecting line of upper region 1 and lower region 3a, 3b (longitudinal direction). The compartments 3a, 3b are shorter than the fire extinguishers 10a, 10b which are put into the compartments 3a, 3b, so that the fire extinguishers 10a, 10b project somewhat out of the compartments 3a, 3b and can be gripped and removed quickly.

In FIG. 3, the bag can be seen in the rolled-up state. The bag is rolled up in such a way that the fire extinguishers 10a, 10b are located on the inside and the middle region 2 is wound around the fire extinguishers 10a, 10b. The upper region 1 having the handle opening 9 is located on the outside. In addition, protective gloves 11 and protective glasses 12 are rolled into the bag.

The bag is, for example, kept in the passenger compartment on board an aircraft. Should an electronic device of a passenger, for example a notebook or a smartphone, catch fire, the bag is taken at the handle opening 9, as a result of which the bag automatically rolls up. This is effected by the gravity acting on the fire extinguishers 10a, 10b located in the compartments 3a, 3b.

The protective gloves 11 and the protective glasses 12 fall out in the process and can be put on or donned by the user. The user then removes one of the fire extinguishers 10a and extinguishes the burning device 18 therewith. Following the extinguishing of the fire, the extinguished device 18 is laid in the bag through the opening 7. If the device 18 has started to burn again, fire-extinguishing agent can be sprayed into the bag with the fire extinguisher 10a or with the second fire extinguisher 10b. Then, the two hook-and-loop tapes 8a, 8b are brought onto each other and the opening 7 of the bag is closed. In this way, the device 18 is kept in a fireproof manner.

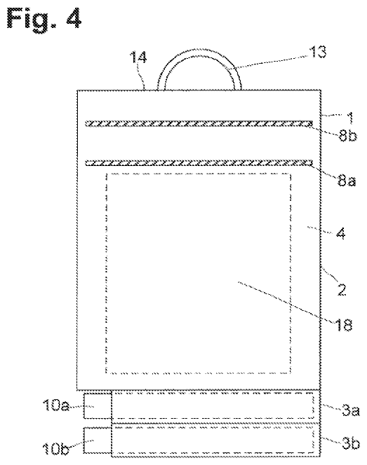

An alternative embodiment of the invention is shown in FIG. 4. The same designations refer to the same elements in all the Figures.

The design according to FIG. 4 differs from that according to FIGS. 1 to 3 in that the opening 14 of the bag is located at its upper end. The interior of the bag is directly accessible from above.

Instead of the handle opening 9, one or two handle grips 13 are provided. In the design with two handle grips 13, one of the handle grips 13 is fixed to the front part 4 and the other hand grip 13 to the rear part. By moving the two handle grips 13 apart, the opening 14 of the bag is opened, so that an object 18 can be brought simply into the inner compartment of the bag. If only one handle grip 13 is provided, then this is fixed either to the front part 4 or the rear part. In another embodiment, the bag has no handle,

All further elements of the bag correspond to the bag shown in FIGS. 1 to 3. The bag according to FIG. 4 is rolled up in an analogous way and unrolled as needed and is used as explained above by FIGS. 1 to 3.

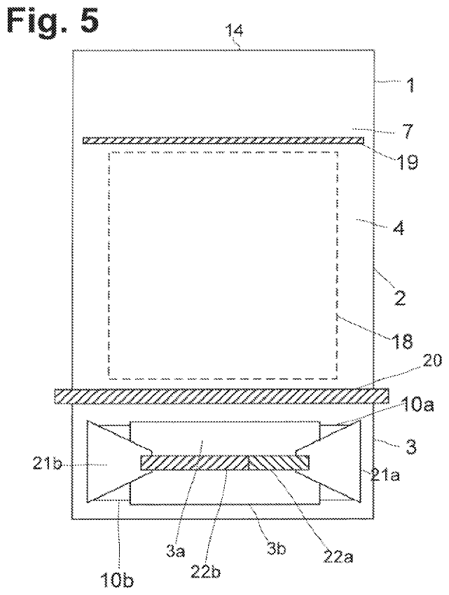

Finally, a further variant of the invention is illustrated in FIG. 5. Once more, the same designations refer to the same elements.

The bag according to FIG. 5 has the opening 14 at the upper end, in a way analogous to the design according to FIG. 4. The upper edge of the bag can be provided with a reinforcing strip, so that the opening 14 can be opened more easily.

To close the inner compartment, a roll hook-and-loop fastener 19 is provided. For this purpose, the bag is rolled together from the top as far as a hook-and-loop fastener strip 19, after that it is rolled a second time and in the process it is closed with a second hook-and-loop fastener strip, not illustrated in the Figure. (This second hook-and-loop fastener strip is fitted to the rear side underneath the opening 14) The inner compartment is closed in an essentially gas-tight manner as a result.

The lower region 3 of the bag is fixed by means of a further hook-and-loop tape 20 in the middle region 2 of the bag. The hook-and-loop tape 20 projects beyond the edge of the bag on at least one side of the bag, so that the hook-and-loop tape 20 can easily be gripped and released. The lower region having the fire extinguishers 10a, 10b can therefore be separated quickly and easily from the rest of the bag.

In FIG. 5, the outer compartments 3a, 3b are provided with two tabs 21a, 21b. The two tabs 21a, 21b are fixed to the lower part 3 of the bag and can be folded inward in the transverse direction. When they are folded inward, the two tabs 21a, 21b close the openings of the outer compartments 3a, 3b and hold the fire extinguishers 10a, 10b. Two hook-and-loop tapes 22a. 22b, which are each attached to the tabs 21a, 21b, can be connected to each other, by which means the tabs 21a, 21b are fixed in the state folded inward.

None of the details shown in FIGS. 1 to 5 are restricted to the respective embodiment but can also be used in other variants.

1-15. (canceled)

16. A flexible bag, comprising:
an inner compartment for receiving a hot and/or a burning object, wherein the bag is rollable up and/or foldable;
an opening for insertion of the hot and/or the burning object into the inner compartment, wherein the opening is disposed in an upper third of the flexible bag;
wherein an extent of the flexible bag from an upper end to an opposite lower end defines a longitudinal direction of the flexible bag; and
an outer compartment that is accessible from an outside of the bag, wherein a fire extinguisher that discharges a fire-extinguishing agent is housed in the outer compartment, wherein the outer compartment is disposed at a lower third of the flexible bag which is opposite the opening, and wherein the outer compartment is configured such that the fire extinguisher is disposed essentially perpendicular to the longitudinal direction of the bag.

17. The flexible bag according to claim 16, wherein a part of the flexible bag on which the outer compartment is disposed is detachably connected to a rest of the bag.

18. The flexible bag according to claim 17, wherein the part of the flexible bag on which the outer compartment is disposed is detachably connected to the rest of the bag by a hook-and-loop connection.

19. The flexible bag according to claim 16, wherein the flexible bag or at least a part of the flexible bag on which the outer compartment is not disposed consists of a fire-retardant material or a fire-resistant material.

20. The flexible bag according to claim 16 further comprising a handle, wherein the handle is disposed on an end of the flexible bag that is opposite to the outer compartment.

21. The flexible bag according to claim 16, wherein the opening is closable with a hook-and-loop fastener.

22. The flexible bag according to claim 16 further comprising a second outer compartment, wherein a second fire extinguisher that holds and discharges a fire-extinguishing agent is housed in the second outer compartment.

23. The flexible bag according to claim 16 further comprising fire-resistant gloves and/or protective glasses disposed in the outer compartment.

24. The flexible bag according to claim 16, wherein the fire-extinguishing agent is disposed in an elastic filling bladder.

25. The flexible bag according to claim 16 further comprising a tab and wherein the outer compartment is closable by the tab.

26. The flexible bag according to claim 16, wherein the flexible bag has a rectangular cross section.

27. The flexible bag according to claim 16 further comprising a data carrier disposed on the flexible bag.

28. The flexible bag according to claim 27, wherein the data carrier is a radio frequency identification (RFID) data carrier.

29. The flexible bag according to claim 16 in combination with the hot and/or the burning object, wherein the hot and/or the burning object is disposed in the inner compartment and wherein the hot and/or the burning object contains a battery based on lithium compounds.

30. A method for extinguishing a hot and/or a burning object with the flexible bag according to claim 16, comprising the steps of:
extinguishing the hot and/or the burning object with the fire extinguisher from the flexible bag; and
inserting the object into the flexible bag after the extinguishing.
